(19) United States
(12) Patent Application Publication
(10) Pub. No.: US 2008/0094205 A1
(43) Pub. Date: Apr. 24, 2008

(54) WIRELESS SENSOR FRAMEWORK

(75) Inventor: Jeffrey Howard Thorn, Ellicott City, MD (US)

Correspondence Address: DLA PIPER US LLP, P. O. BOX 9271, RESTON, VA, 20195, US

(73) Assignee: OCTAVE TECHNOLOGY INC., ELLICOTT CITY, MD (US)

(21) Appl. No.: 11/876,391

(22) Filed: Oct. 22, 2007

Related U.S. Application Data
(60) Provisional application No. 60/853,575, filed on Oct. 23, 2006.

(51) Int. Cl. G08B 1/08

(52) U.S. Cl. 340/539.1

(57) ABSTRACT

A gateway connected to a Wireless Sensor Network (WSN) for transfer of data with the WSN includes a data reader interface configurable to read sensor data from the WSN received from a communication port connected to the WSN, irrespective of a type of hardware or software used in the WSN. The gateway also includes an application profile interface configurable to receive the sensor data read by the data reader interface and convert the received data into a generic read data message irrespective of the type of hardware or software used in the WSN and a data handler interface configured to receive the generic read data message, process the received generic read data message based on a customized requirement or a standard requirement for the sensor data and send the processed data to a back-end network.

This application is based on and derives the benefit of U.S. Provisional Patent Application No. 60/853,575 filed on Oct. 23, 2006, the contents of which are incorporated herein by reference.

The present disclosure generally relates to a Wireless Sensor Framework (WSF).

### BRIEF DESCRIPTION OF THE DRAWINGS

Reference is made to the attached drawings, wherein elements having the same reference designations represent like elements throughout wherein:

FIG. 1 is a block diagram illustrating a Wireless Sensor Framework (WSF) according to an exemplary disclosed embodiment;

FIG. 2 is a class diagram illustrating a gateway used in the WSF according to an exemplary disclosed embodiment;

FIG. 3 is a class diagram illustrating aspects of a gateway used in the WSF in detail according to an exemplary disclosed embodiment;

FIG. 4 is a class diagram illustrating other aspects of a gateway used in the WSF in detail according to an exemplary disclosed embodiment;

FIG. 5 is a class diagram illustrating yet other aspects of a gateway used in the WSF in detail according to an exemplary disclosed embodiment;

FIG. 6 illustrates a configuration used to specify software modules for the WSF according to an exemplary disclosed embodiment;

FIG. 7 is a flow chart illustrating a method for creating user defined application profiles and user defined data readers according to an exemplary disclosed embodiment;

FIG. 8 is a flow chart illustrating a method for reading data from a Wireless Sensor Network (WSN) to the WSF according to an exemplary disclosed embodiment; and

FIG. 9 is a flow chart illustrating a method for writing data from a WSF to a WSN according to an exemplary disclosed embodiment.

### DETAILED DESCRIPTION OF SEVERAL EMBODIMENTS

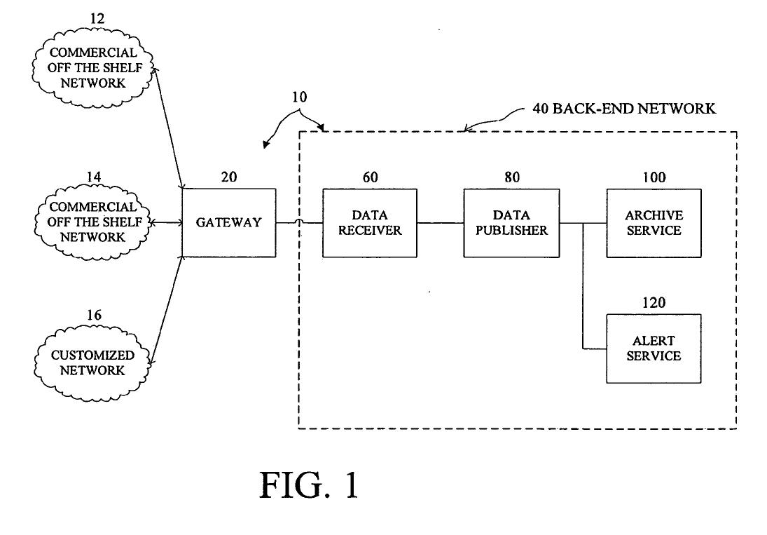

FIG. 1 illustrates a block diagram of a WSF 10 connected to Wireless Sensor Networks 12-16 according to an exemplary disclosed embodiment. Wireless Sensor Networks 12 and 14 may be commercial off-the-shelf networks and Wireless Sensor Network 16 may be a customized wireless sensor network. WSF 10 includes a gateway 20 and a back end network 40. The back end network 40 may include a data receiver 60, a data publisher 80, an archive service 100, and/or an alert service 120. For example, back end network may include data receiver 60, data publisher 80, and archive service 100 only. In addition, any other combination of devices configurable to use sensor data may be part of back end network 40 without departing from the scope of the disclosure.

In an exemplary embodiment, Wireless Sensor Networks 12 and 14 are commercially available networks. These commercially available networks may include, for example, TinyOS network, Dust Network, Contiki, MANTIS, BTnut, SOS and Nano-RK. In addition, any other network that is commercially available may be connected to WSF 10. In addition, a customized WSN 16 may also be connected the WSF 10. Customized WSN 16 is a WSN whose sensor nodes are made of customized hardware or whose sensor nodes operate on a customized Operation System or a combination of both. While FIG. 1 illustrates three WSNs connected to WSF 10, one skilled in the art will appreciate that any number of WSN may be connected to WSF 10 without departing from the scope of the disclosure. Furthermore, as is well known, each of WSN 12-16 generally includes distributed autonomous devices that use sensors to cooperatively monitor physical or environmental conditions, such as temperature, sound, vibration, pressure, motion or pollutants, at different locations.

Generally, in an exemplary embodiment, WSF 10 collects sensor data from WSN 12-16, translates the collected data into a generic data form, and transmits this data that is now in a generic form to end users. The sensed data may then be used for different purposes such as, for example, enabling control, providing data trends and providing alerts to end-users. Specifically, gateway 20 reads the sensor data by using software modules that are specific to the type of WSN 12-16 connected to WSF 10. Furthermore, the gateway 20 uses software modules specific to the type of WSN 12-16 to convert the read data into a generic data form. The gateway 20 then transfers the generic data to back end network 40. Data receiver 60 in back end network 40 aggregates the received data and forwards the aggregated data to data publisher 80. Data publisher 80 pulls all the incoming data off data receiver 60 and forwards the data to any applications that may have registered an interest in using the data. For example, archive service 100 may store the data into one or more databases, whereas alert service 120 may use the data to provide alerts to end users.

In an exemplary embodiment, WSF 10 may be configured for bidirectional transfer of data. Specifically, WSF 10 is configured to collect data from WSN 12-16, convert the collected data into a generic form, and transfer the generic data to end users. In addition, or alternatively, WSF 10 can also be configured to listen for data to be written to a specific WSN 12-16, convert the write-data into a data format compatible with the specified WSN 12-16, and transfer the write-data to the specified WSN 12-16. The process of converting the write-data into a data format compatible with the specified WSN 12-16 and transferring the write-data to the specified WSN 12-16 is performed by software modules specific to the type of WSN 12-16 to which the write-data is transferred.

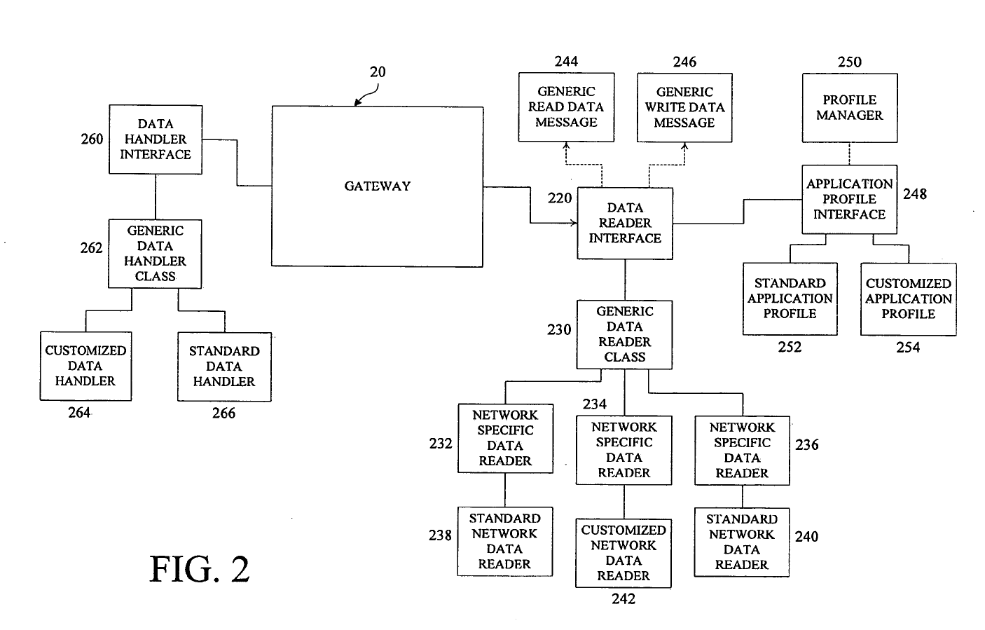

FIG. 2 is a class diagram illustrating the software components of gateway 20 according to an exemplary disclosed embodiment. Gateway 20 includes a data reader interface 220. Data reader interface 220 is a software interface that includes functionality to communicate with specific WSN 12-16. The functionality of Data reader interface 220 is inherited by generic data reader class 230. That is, generic data reader class 230 abides by rules set out in data reader interface 220 to read data from specific WSN 12-16. Furthermore, the functionality of generic data reader class 230 is inherited by network-specific data readers 232-236. Network-specific data readers 232-236 are software classes that include more specific implementations of the generic data reader class 230. In an exemplary embodiment, network-specific data readers 232-236 include implementations that are specific to the type of communication networks that are used to connect to the WSN 12-16. The functionality of network-specific data readers 232-236 is inherited by standard network data readers 238-240 and customized network data reader 242. Standard network data readers 238-240 are software classes that read data from commercial off-the-shelf WSN such as WSN 12 and 14 shown in FIG. 1. Customized data reader 242 is a data reader class that is configured to read data from customized WSN such as WSN 16 shown in FIG. 1.

Gateway 20 is configured to convert data read by data reader interface 220 to a generic read data message 244. Also, gateway 20 is configured to receive a generic write data message 246 and convert the received generic write data message into a data format suitable for a specified WSN 12-16. Specifically, Application Profile Interface 248 converts data collected from WSN 12-16 to generic read data message 244 and converts generic write data message 246 to data specific for a WSN 12-16. In an exemplary embodiment, multiple application profile interfaces may be used, each corresponding to a separate WSN 12-16. To this end, Profile Manager 250 is used to determine an appropriate application profile interface 248 based on the type of WSN 12-16 from which data is sensed or to which data is written. Alternatively, an appropriate application profile may be determined based on a unique identifier sent from a node within a WSN 12-16. For example, one or more bits in a data packet sent by a WSN 12-16 may indicate the type of information being sensed by a node within WSN 12-16 and/or the type of hardware used in WSN 12-16.

Application Profile Interface 248 is inherited by a Standard Application profile 252 and a Customized Application Profile 254. That is, standard application profile 252 and customized application profile 254 are software classes that inherit all the rules and functionality specified in application profile interface 248 but also include configurations specific to standard WSN 12-14 and customized WSN 16, respectively. In an exemplary embodiment, standard application profile 252 is used to convert raw sensor data obtained from commercial off-the-shelf networks 12 and 14 to generic read data message 244. Also, customized application profile 252 is used to convert raw sensor data obtained from customized network 16 to generic read data message 244.

After converting collected sensor data into a generic read data message 244, gateway 20 processes the generic data message in a manner such that the data can be used by end users of WSF 10. To this end, gateway 20 includes data handler interface 260. Data handler interface 260 includes a number of implementations. These implementations process the received generic read data message based on a customized requirement or a standardized requirement for the sensor data and send the processed data to back end network 40. In an exemplary embodiment, data handler interface 260 defines rules and functionality that are inherited by the generic data handler class 262. Generic data handler class 262 conforms to rules defined by data handler interface 260. Furthermore, generic data handler 262 provides a generic implementation of the functions defined in the data handler 262. The generic implementation provided by the generic data handler 262 can be adapted to form a customized data handler 264 and a standard data handler 266. That is, customized data handler 262 and a standard data handler 266 are software classes that inherit all the rules defined by generic data handler 262 but are adapted to process and handle data based on standardized requirements of an end user or custom requirements defined by an end user, respectively.

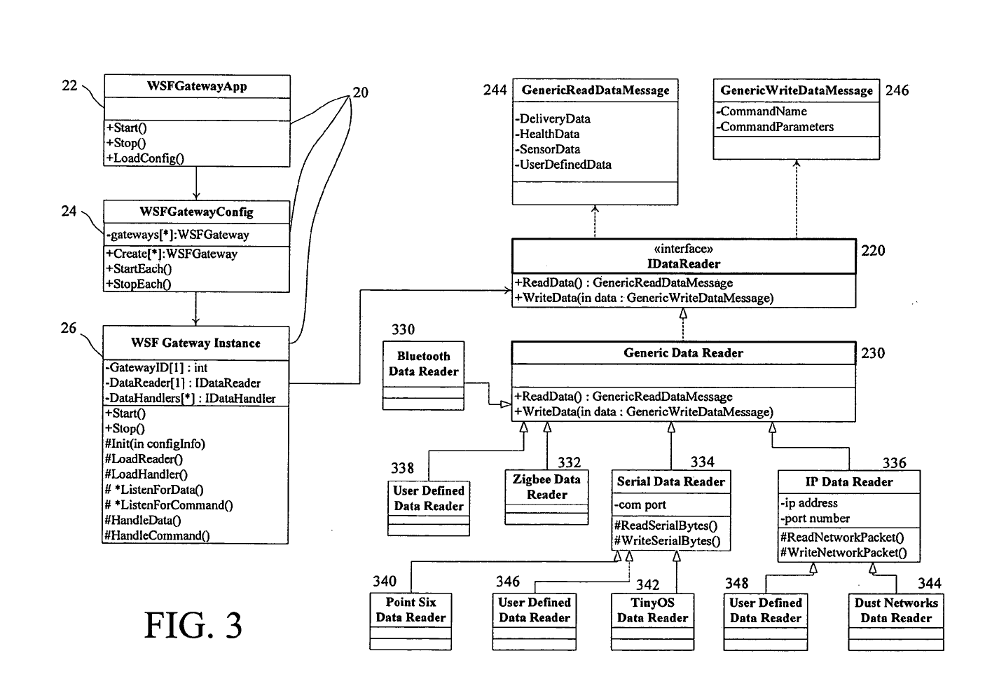

FIG. 3 is a class diagram illustrating the software components of gateway 20 according to an exemplary disclosed embodiment in greater detail. Most of the components of FIG. 2 are replicated in FIG. 3. However, some components from FIG. 2 are illustrated in greater detail in FIG. 3. Specifically, FIG. 3 includes examples of more specific implementations of data reader interface 220. As shown in FIGS. 2 and 3, gateway 20 includes a number of software classes. Furthermore, the software classes bear a certain relationship to each other. These relationships are defined in FIG. 3

Each box in FIG. 3 represents a class. Each class is a single abstract data structure associated with attributes and functions. In an exemplary embodiment, each class contains at least three levels. The top level is the name of the class. The middle level includes attributes of the class, and the bottom level includes functions the class can provide. These functions can be public functions or private functions. Public functions are those that can be called by any other class. Private functions are those that can be called internally by the class itself. In FIG. 3, a “#” sign indicates that the function is a private function while a “+” sign indicates a public function.

The relationships between the various classes are denoted by the arrows connecting each class to the other. The type of arrow denotes a particular relationship between each class on either end of the arrow. In an exemplary embodiment, a solid open-headed arrow represents an association between two classes. That is, one class can call a function in another class. A dotted open-headed arrow indicates a dependency between classes. That is, a class below depends from a class above. A dotted closed arrow indicates a realization relationship. That is, a class below realizes or implements an interface defined by the class above. A solid closed-headed arrow indicates a specific implementation of the class above. Furthermore, each class may be created by using any programming language such as, for example, .NET, C, C++, Java, etc.

In an exemplary embodiment, gateway 20 includes a configuration file. This configuration file may be a text based file that is parsed by gateway 20 to determine which implementations of data reader interface 220 to load. In an exemplary embodiment, the configuration file may be written in XML (Extendable Mark up Language). As seen in FIG. 3, gateway application 22 loads the configuration file using the “LoadConfig” function. Specifically, the “LoadConfig” function creates the next object down below which is GatewayConfig object 24. GatewayConfig object 24 reads through the XML configuration file and finds every instance of gateway 20 that needs to be created as per the configuration file. Thus, multiple instances of gateway 20 may be created. The number of instances of gateway 20 created will depend on the configuration bits in the gateway configuration file. Thus, while FIG. 3 illustrates one instance of gateway 20, any number of instances of gateways 20 may be created as per the configuration file without departing from the scope of the disclosure. In an exemplary embodiment, the number of instances of gateway 20 created depends on the different types of WSN present in the WSF 10. For example, one instance of gateway 20 may be created to receive data from a Dust Network WSN. Another instance of gateway 20 may be created to receive data from a TinyOS WSN. Yet another instance of gateway 20 may be created to receive data from a customized WSN, i.e., a user defined WSN.

In FIG. 3, an exemplary instance of gateway 20 is gateway instance 26. Gateway instance 26 includes a gateway ID that is a unique identifier of gateway instance 26. Furthermore, gateway instance 26 includes a “DataReader” attribute and a “DataHandler” attribute. Each attribute indicating that gateway instance 26 can load a data reader and a data handler. Gateway instance 26 includes a number of public and private functions. The public functions are “Start” and “Stop” that create or destroy, respectively, background threads that listen for incoming sensor data or outgoing commands. In addition, gateway instance 26 includes a “LoadReader” function, a “LoadHandler” function, “ListenforData” function, a “ListenForCommand” function, a “HandleData” function, and a “HandleCommand” function. The LoadReader” and “LoadHandler” functions are used to load Data Reader Interface 220 and Data Handler Interface 260, respectively. The “ListenforData” and “ListenForCommand” functions are used to listen for data coming from any WSN and for commands to be written to any WSN, respectively. Furthermore, the “HandleData” function is used to process data using the Data Handler Interface 260.

Gateway instance 26 uses the LoadReader function to load Data Reader Interface 220. Data Reader Interface 220 is configurable to read data from any type of WSN irrespective of the type of hardware or software used in the WSN. In addition, data reader interface is configurable to write data to any type of WSN irrespective of the type of hardware or software used in the WSN. Data Reader interface 220 uses a “ReadData” function to read data and a “Write Data” function to write data.

As mentioned above, data reader interface 220 is configurable to read and write data from and to any WSN irrespective of the type of hardware or software used in the WSN. In an exemplary embodiment, this is achieved by gateway 20 instantiating a data reader that is based on functionality defined in generic data reader class 230. Generic data reader class 230 abides by all rules defined by Data reader interface 220. Furthermore, generic data reader class 230 provides default functionality and can be customized to read and write data from and to any WSN irrespective of the type of hardware or software used in the WSN. For example, as discussed in FIG. 2, generic data reader class can be used to create network specific data readers 232 and 236. Referring back to FIG. 3, in an exemplary embodiment, network specific data readers 232 and 236 are Bluetooth data reader 330, Zigbee Data Reader 332, Serial Data Reader 334, IP (Internet Protocol) Data Reader 336, and a User Defined Data Reader 338.

Each of the above-listed network specific data readers are software classes configured to read data from a specific network type. Thus, for example, Bluetooth data reader 330 includes functionality to read and write data to and from a Bluetooth network. Similarly, Zigbee Data Reader 332 includes functionality to read and write data to and from a Zigbee network. As is well known, both Bluetooth and Zigbee are industrial specifications for data communication across Wireless Personal Access Networks (PAN). In an exemplary embodiment, a WSN may use a Bluetooth or Zigbee based PAN to connect to WSF 10. In such a case, gateway 20 will be capable of reading and writing data from and to such a WSN via Data Reader Interface 220. This is because Data Reader Interface 220 is now configurable to communicate with such a WSN via Bluetooth Data Reader 330 or Zigbee Data Reader 332. While Bluetooth Data Reader 330 and Zigbee Data Reader 332 are shown in FIG. 3, gateway 20 may communicate with any WSN over any other type of PAN by configuring a data reader compatible with the corresponding PAN without departing from the scope of the disclosure.

Furthermore, as shown in FIG. 3, data reader interface 220 is also configurable to read data from WSN connected to gateway 20 via a serial communication network. To this end, serial data reader 334 may be used to read data from a WSN connected to gateway 20 via a serial communication port. As seen in FIG. 3, serial data reader 334 includes all the attributes and functionality needed to read data from a serial network. For example, serial data reader 334 includes the attributes for reading data from a serial type communication port (-com port).

Similarly, data reader interface 220 is also configurable to read data from WSN connected to gateway 20 via an IP network. To this end, IP data reader 336 includes attributes and functions needed to read data from a WSN connected to gateway 20 via an IP communication port. For example, as seen in FIG. 3, IP data reader 336 includes an ip address and a port number in order to communicate with a WSN over an IP connection. In addition, a user may create a User Defined Data Reader 338 that will be able to read data from a WSN that is connected to gateway 20 via a non-standard network. That is, based on the type of network connecting gateway 20 to a WSN, a user can extend generic data reader class 230 to create user defined data reader 330 that is specially adapted to read data over the non-standard network. Thus, gateway 20 is configurable to read data from any WSN irrespective of the network over which the WSN is connected to gateway 20.

FIG. 3 also illustrates the type of WSN from whom Data Reader Interface 220 can read sensor data. As seen in FIG. 3, Point Six Data Reader 340 and TinyOS Data Reader 342 are data readers who inherit the attributes and functionality of Serial Data Reader 334 and who include additional configurations to read from a Point Six WSN and a TinyOS WSN, respectively. Also, Dust Networks Data Reader 344 inherits the attributes and functionality of IP Data Reader 336 but includes additional configuration specific to a Dust Network WSN. As is well known, Point Six WSN, TinyOS WSN and Dust Networks are commercially available WSN that communicate over a Serial Network or IP Network with gateway 20.

In addition, a user can create User Defined Data Readers 346 and 348. User Defined Data Readers 346 and 348 denote a customized data reader that can be created by a user to read data from a WSN that is proprietary in nature. That is, a WSN whose data cannot be read by a standard data reader can have its data read by user defined data reader 346 or 348 that is specifically adapted to read data from the proprietary WSN.

The number and type of data reader interfaces loaded by gateway instance 26 will depend on the configuration bits in the configuration file loaded on gateway 20. In an exemplary embodiment, each data reader interface 220 may be created to read data from a specific type of WSN. Furthermore, while the discussion above focuses on how sensor data may be read from different types of WSN, the same software classes discussed above may be used to write data/send commands from gateway 20 to a specific WSN. For example, serial data reader 334 and TinyOS data reader 342 may be used to write data/send commands from gateway 20 to a TinyOS WSN. Similarly, serial data reader 334 and User Defined data reader 346 may be used to write data/send commands from gateway 20 to a proprietary WSN.

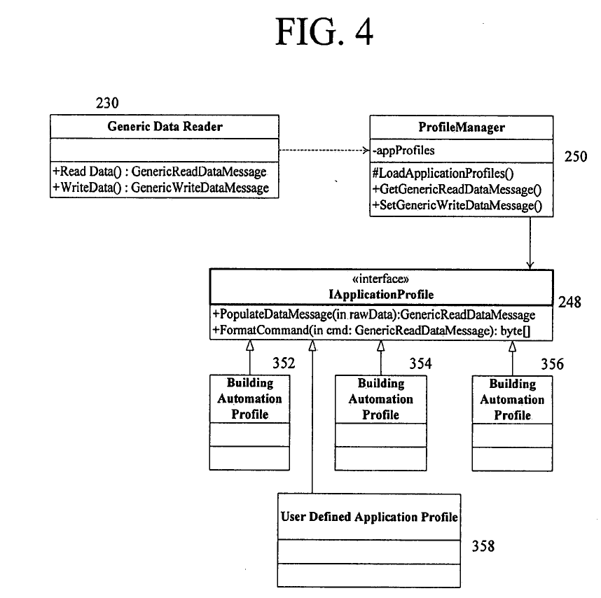

FIG. 4 includes examples of more specific implementations of Application Profile Interface 248. Similar to FIG. 3, all the components shows in FIG. 4 are software classes which bear relationships defined, by the types of arrows between each class. Furthermore, the generic structure of each class is similar to that discussed with respect to FIG. 3. Therefore, a discussion of the generic format of each class and the relationship between classes has been omitted to avoid redundancy of information.

As discussed above with respect to FIG. 2, Application Profile Interface 248 converts data collected from a WSN to generic read data message 244 and converts generic write data message 246 to data specific for a WSN 12-16. In FIG. 4, Application Profile Interface Class 248 is inherited by specific application profiles. These specific application profiles include Building Automation Profile 352, Environmental Monitoring Profile 354, Machine Health Profile 356, and User Defined Application Profile 358.

Each specific application profile 352-358 is adapted to convert sensor data specific to the particular application into a generic read data message 244. In an exemplary embodiment, converting the read data includes determining an appropriate application profile by extracting information from the read data that helps determine the appropriate application profile. The determined application profile is configured to extract the required data from the read sensor data, convert the extracted data into appropriate engineering units and populate generic read data message 244 with the converted data.

A data reader and profile manager 250 are configurable to determine an appropriate application profile to use for a given packet of incoming data. This determination may be made based on information within the incoming data. In an exemplary embodiment, this is done by extracting a “key” from the read sensor data. This “key” may be a particular byte number, an alphanumeric number, or a text field that indicates the type of application profile to use for converting the read sensor data into a generic read data message. In addition, any other type of identifier may be used as a “key to determine the appropriate application profile. Thus, for example, if data is read from TinyOS data reader 342, profile manager 250 inspects the data packet read by TinyOS data reader 342. Because data is read from a TinyOS network, profile manager 250, based on its configuration, knows that a TinyOS Application profile interface should be used to convert the read sensor data. Furthermore, profile manager 250, again based on its configuration, knows that byte 17 of the data stream read from a TinyOS network will indicate the type of sensor data being read. In an exemplary embodiment, byte 17 may include information indicating that the sensor data pertains to environmental data such as, for example, temperature or pressure being monitored by a TinyOS WSN. In this case, profile manager 250 ensures that the read data is transferred to Environmental Monitoring Profile 354.

Environmental Monitoring Profile 354 is configured to extract the actual sensor data pertaining to the environmental parameters monitored. In an exemplary embodiment, this extracted data is in a binary format. The extracted data in binary format is then converted into appropriate engineering units by environmental monitoring profile 352. Environmental monitoring profile 352 adds this converted data to the data structure of generic read data message 244. Thus, the generic read data message includes environmental sensor data obtained from a TinyOS WSN that is now readable by an end user.

While the above-mentioned example discusses the use of environmental monitoring profile 354, a similar process may be used to read and convert sensor data pertaining to building automation by using building automation profile 352. Alternatively or in addition, machine health sensor data may be read and converted into generic read data message 244 by using machine health profile 356. In addition, if a WSN is used to sense data that cannot be converted by a standard application profile, WSF 10 allows for the creation of user defined application profile 358. User application profile 358 may be configured by using the rules and attributes defined by application profile interface 248 but by adding further configuration bits in order to make user application profile 358 compatible with the type of proprietary parameters being sensed by a data reader.

While the exemplary embodiments discussed above discuss how an application profile converts raw sensor data into a generic read data message, a similar process may be used to convert data/commands destined for a particular WSN from generic write data message 246 format to a format suitable for a WSN. That is, data/command that needs to be sent to a particular WSN may be converted from generic write data message 246 format to a format suitable for the particular WSN by using a corresponding application profile.

Furthermore, while the discussion above focuses on profile manager 250 determining the appropriate application profile for data conversion, in an alternative exemplary embodiment, the functionality of profile manager 250 may be collapsed into that of a data reader. In particular, data readers 338-348 may determine the type of application profile to use for data conversion based on the type of data being read from the WSN.

Generic read data message 244 includes general information in addition to sensor data received from data readers 338-348. In an exemplary embodiment the information may include delivery data, application data, health data, and/or sensor data. Delivery data may include routing information for a data packet. This routing information may include, for example, information about the data packet's parent node, the number of hops, etc. The application data may include total message count, the message type, the gateway type, and network ID. Health data may include a device battery voltage and a timestamp the packet was received. Sensor data may include sensor ID, sensor type, sensor value, units, and a timestamp the sample was taken. In addition, generic read data message 244 may also include user defined data that comes from proprietary WSN. Specifically, a proprietary WSN would be one that uses a non-standard hardware or software. Thus, generic read data message 244 may include information from a WSN irrespective of the type of hardware

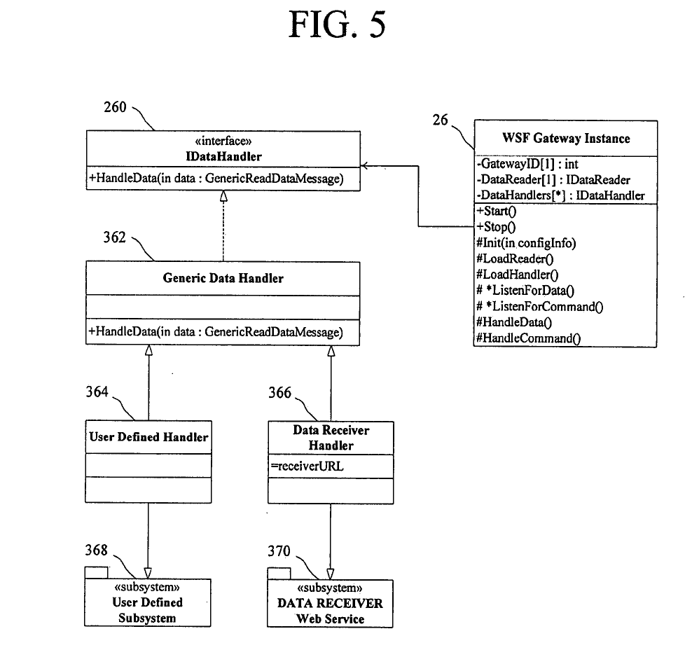

FIG. 5 includes examples of more specific implementations of Data Handler Interface 260 according to an exemplary disclosed embodiment. Similar to FIGS. 3 and 4, all the components shows in FIG. 5 are software classes which bear relationships defined by the types of arrows between each class. Furthermore, the generic structure of each class is similar to that discussed with respect to FIGS. 3 and 4. Therefore, a discussion of the generic format of each class and the relationship between classes has been omitted to avoid redundancy of information.

As mentioned above, data handler interface 260 includes a number of implementations which process the received generic read data message based on a customized requirement or a standardized requirement for the sensor data. These data handler implementations also send the processed data to back end network 40. As seen in FIG. 5, generic data handler class 262 can be adapted to create a user defined handler 364 and a data receiver handler 366. Furthermore, while FIG. 5 discloses one data handler interface 260, gateway instance 26 can communicate with any number of data handler interfaces 260. The number of data handler interfaces instantiated may depend on the configuration bits in the configuration file loaded on gateway 20.

In an exemplary embodiment, data receiver handler 366 is a specific data handler class that inherits the functions and attributes of generic data handler class 262. Furthermore, data receiver handler 366 includes configuration bits specific to performing a data receiver service. Specifically, by using the Handle Data method in gateway instance 26, data receiver handler 366 receives generic read data message 244, converts generic read data message 244 into an XML format, and posts the converted data to Data Receiver web service 370 for use by back end network 40. In addition, to data receiver handler 366, any number of standard data handler classes may be created and used by adapting generic data handler class 262 for the specific use.

Furthermore, in case an end user needs to handle data in a customized manner, i.e., in a manner not provided for by built-in software classes in WSF 10, a user may create user defined data handler 364. In an exemplary embodiment, user defined handler 364 may be created by using the attributes and functionality defined by generic data handler class 262 to create a data handler that can process data in a manner defined by the user. The data processed by user defined handler 364 may then be sent to a user defined subsystem 368.

In an exemplary embodiment, gateway 20 may be software that is loaded on a single physical device. This physical device may generally include a CPU (Central Processing Unit), RAM (Random Access Memory), ROM (Read Only Memory), and any other piece of hardware suitable for performing the functions of gateway 20. Alternatively, the functionality of gateway 20 may be distributed over multiple physical devices. That is, the software classes disclosed in FIGS. 2-5 may be distributed over a plurality of physical devices. For example, one physical device including a CPU, RAM, and ROM may include data reader interface 220, another may include application profile interface 248, and yet another may include data handler interface 260. In another alternative exemplary embodiment, data reader interface 220 and application profile interface 248 may be included in one physical device and data handler interface 260 may be included in another physical device. Furthermore, any other combination of physical devices may be used to provide the functionality of gateway 20 without departing from the scope of the disclosure.

In yet another exemplary embodiment, the functionality of gateway 20 may be included in specialized hardware in the form of, for example, Application Specific Integrated Circuits (ASICS.) That is, the functionality of gateway 20 may be performed in hardware instead of software. Alternatively, part of the functionality of gateway 20 may be performed in hardware and part in software, without departing from the scope of the disclosure.

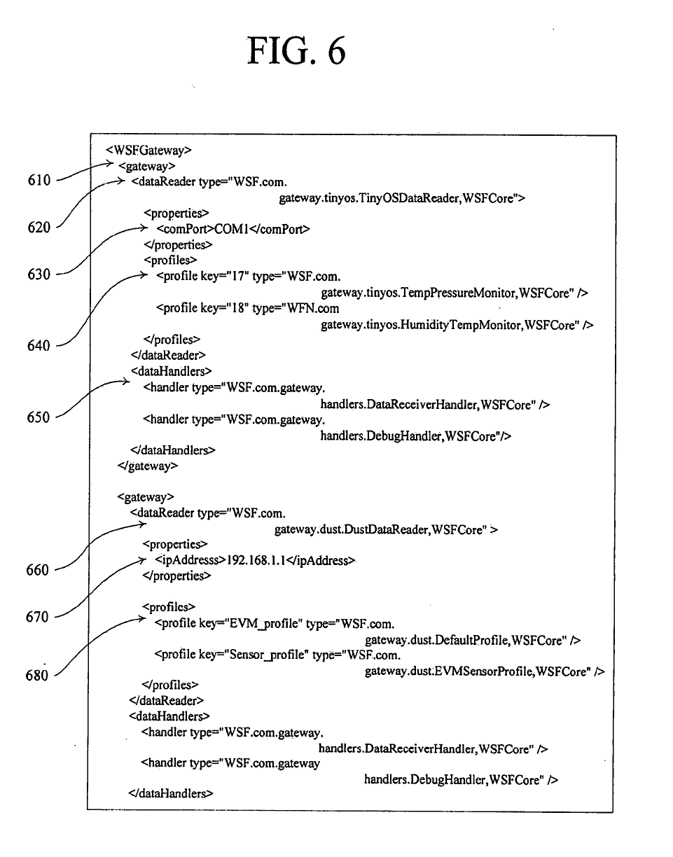

FIG. 6 illustrates configuration 600 used to specify software modules for the WSF according to an exemplary disclosed embodiment. Specifically, in an exemplary embodiment, configuration 600 may be part of a configuration file for gateway 20. The callouts numbered 610-680 detail exemplary features of configuration 600. Furthermore, the configuration shown in FIG. 6 will be explained with respect to FIGS. 3-5. 610 denotes features associated with the <WSFGateway> element which is the root element. All information within this element describes a single deployment of a WSF Gateway application. In an exemplary embodiment, any number of Gateway applications can be running at one time in any location. The WSF Data Receiver web service can collect data from all running Gateway instances.

620 denotes features associated with a new WSFGateway object. GatewayConfig object 24 reads each <gateway> element and sends the contents to the Init( ) method of the new WSFGateway object. In this example, the WSNGatewayConfig class will create two gateways. The WSFGateway object reads the <dataReader> element to determine which Data Reader Interface 220 type to create. If the class specified in the “type” attribute does not implement the required Data Reader interface, an error will occur. In this example, a TinyOSDataReader is created in the first gateway and a DustDataReader is created in the second gateway.

630 denotes features associated with a data reader. Because the TinyOSDataReader is derived from (is a subclass of) the SerialDataReader, it inherits all properties of the SerialDataReader. In this example, it inherits the <comPort> property. 640 denotes features associated with application profiles. All application profiles used by this DataReader are specified in the <profiles> element. These values are passed to the ProfileManager where each class specified in the “type” attribute of the <profile> element is created and stored along with its key for easy lookup.

650 denotes features associated with data handlers. All data handler implementations used by this WSFGateway object are specified in the <dataHandlers> element. The WSFGateway will create each DataHandler class specified in the “type” attribute of each <handler> element in its LoadHandlers( ) method. In this example, a WSF DataReceiverHandler (sends data to Data Receiver web service) and a DebugHandler (logs data to log file) are created.

660 denotes features associated with a second WSF object. GatewayConfig object 24 creates a secondWSF object. This time, Data Reader Interface 220 is specified as a DustDataReader. The two WSFGateway objects, once started, will run concurrently in their own thread collecting data and sending it to their respective handlers. 670 denotes features associated with a Dust Networks Data Reader. Because the DustDataReader is derived from the IPDataReader class, it inherits all the properties of that class. In this case, it inherits the <ipAddress> property.

680 denotes features associated with application profiles of the Dust Network WSN. Two ApplicationProfile classes are created for use by the DustDataReader, the DefaultProfile (reads default sensors on a Dust mote) and the EVMSensorProfile (read the environmental sensors on a Dust mote). In an exemplary embodiment, the key is a text field instead of a number. However, the key value can be anything that can be read by the corresponding DataReader. In this case, the Dust motes provide a text description of their data when it is delivered instead of a raw binary digit. Therefore, in this case, that text field can serve as the key for the appropriate ApplicationProfile.

The above-discussed configuration is exemplary only. Variations may be made to the configuration of gateway 20 based on the particular requirements of a user of WSF 10. To this end, as discussed above, user defined data readers, user defined application profiles, and user defined data handlers may be created by using the software classes provided by WSF 10.

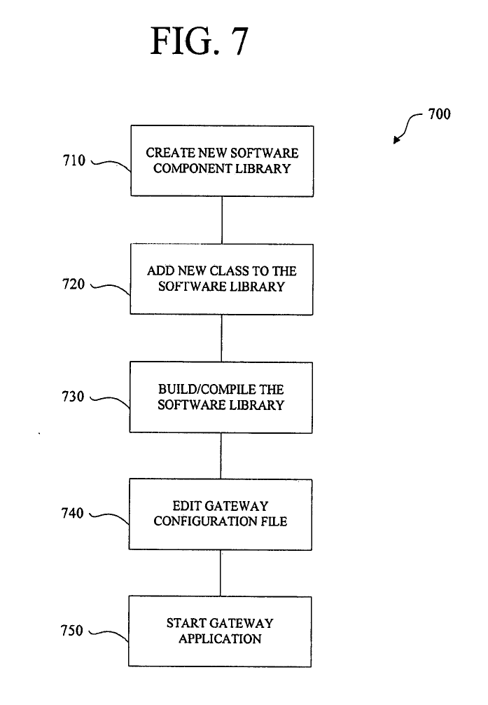

FIG. 7 is a flow chart illustrating a method 700 for creating user defined application profiles and user defined data readers according to an exemplary disclosed embodiment. In many cases, one of the existing DataReader classes can be reused by the user to acquire data from their device. Therefore, there may be a need for only a custom ApplicationProfile class that must be implemented by the user to decipher their data packet. Because the exact steps needed to do so will vary slightly depending on programming language and compiler, the high level steps for building and configuring a custom ApplicationProfile class are outlined below.

At step 710, a new software component library project such as, for example, an assembly, dil, or jar file, depending on the programming environment, is created. At step 720, a new class is added to the software library. In particular, the new class is a “subclass of” or “implements” the Application Profile interface 248 that is defined in the WSF Core Library. Furthermore, the new class implements two methods defined by the Application Profile interface. One method pertains to converting data read by a data reader interface to a generic read data message. The other method pertains to converting a generic write data message to a format specific to a destination WSN.

In an exemplary embodiment, a PopulateDataMessage( ) method will receive the raw binary data and a generic read data message message object that is populated with some initial data. The method must extract any relevant sensor info (or other device info) from the raw data, perform any necessary conversions or calculations, and add the data to the generic read data message. Furthermore, in an exemplary embodiment, a FormatCommand ( ) will receive a generic read data message object and must convert that into a raw binary command that can be understood by the specific type of hardware used in the WSN.

At step 730, the software library is built/compiled. The library file is placed in the same directory as the WSFGateway.exe executable so the application can find the library when it is loaded at run-time. At step 740, the gateway configuration file is edited. Specifically, in the <profiles> section of the <gateway> that will be using the custom application profile, a new <profile> element is added that specifies the key field and the class name of the custom application profile. At step 750, the gateway application is started. Upon starting up, the gateway application will dynamically load the custom class and use it when the Data Reader detects the specified key.

The method for creating user defined data readers is similar to the method for creating user defined application profiles as discussed above. There is, however, a difference at step 720. In an exemplary method for creating a user defined data reader, at step 720, the new class added implements two methods defined by the Data Reader Interface 220. One method is for reading data from a WSN and the other method is for writing data to a WSN.

In an exemplary embodiment, ReadData ( ) will be called by the WSF Gateway to acquire data from WSN hardware. This method communicates with the hardware via the custom communication interface (IP, serial, etc. are already provided by the framework) and obtain a data packet. Furthermore, this method knows how to uniquely identify the data packet to find the right key to look up the appropriate ApplicationProfile class to use. Once the key is found, this method uses the Profile Manager to look up the desired Application Profile to use. Furthermore, it creates a new WSF Data message and passes it to the ApplicationProfile along with the rest of the raw data. In addition, the method will receive a fully populated data message back which can then be returned to the WSF Gateway class for handling.

In an exemplary embodiment, all of the tasks mentioned above will not have to be implemented by the user. Often, the user will extend an existing DataReader class to reuse some of the functionality already provided by the base class. For example, the user might extend the IPDataReader simply to modify what byte location the key is being extracted from. In this case, all other functionality can be used as is.

A Write Data( ) must do the similar tasks above but somewhat in the opposite order. Specifically, the WriteData( ) will receive a generic write data message that describes a specific command. This command is destined for a specific WSN. The Write Data( ) will pass that generic write data message to the ProfileManager. The Profile Manager will lookup which Application Profile is registered to handle that command. Specifically, the Profile Manager determines which Application Profile can convert the command that is currently in a generic write data message format into a format suitable for the hardware and/or software used in the destination WSN. Once the ApplicationProfile is found, it can be used to generate the raw binary format of the command. This method communicates with the custom type of hardware and sends the raw binary command to the device. All other steps discussed in method 600 are applicable towards creating a user defined data reader.

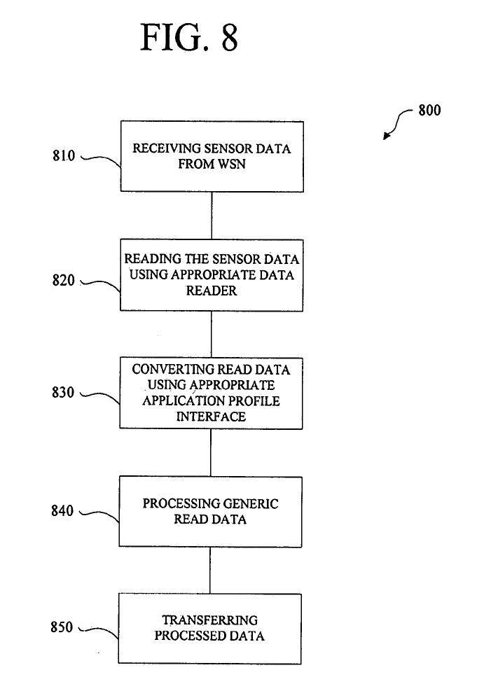

FIG. 8 is a flow chart illustrating a method 800 for reading data from a WSN. At step 810, sensor data is received from a WSN. Furthermore, at step 820, an appropriate data reader is used to read the sensor data from the WSN. The appropriate data reader is determined based on the type of WSN sending the sensor data. For example, if a TinyOS WSN is sending the sensor data, a TinyOS Data reader (e.g., TinyOS Data Reader 342 in FIG. 3) is used to read the sensor data from the TinyOS WSN. The configuration file in gateway 20 may include configuration bits that can make this determination. At step 830, the read data is converted into a generic read data message. This conversion is performed by choosing an appropriate application profile based on the type of data read by the data reader at step 820. Specifically, the chosen application profile converts the raw binary data read by the data reader into appropriate engineering units and populates the data structure of a generic read data message with the converted data. At step 840, the appropriate data handler processes the generic read data message based on the specific rules defined in the data handler. At step 850, the processed data is transferred to the back end network.

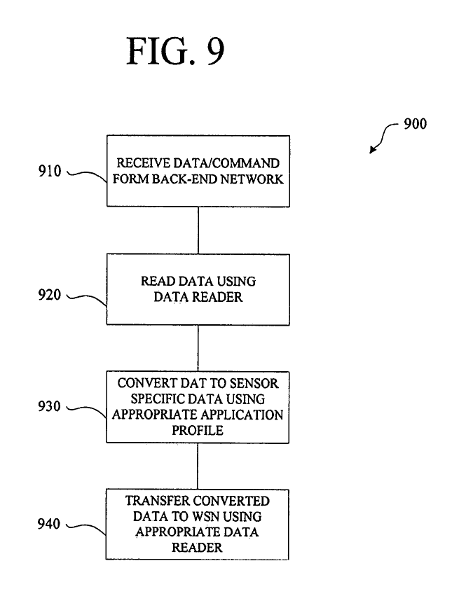

FIG. 9 is a flow chart illustrating a method 900 for writing data/commands to a WSN. At step 910, data/commands destined to a particular WSN are received by gateway 20. At step 920, this received data is read by a data reader. The data reader then determines the appropriate application profile to use to convert the data/command, which may be in the form of a generic write data message, to a sensor specific data format. At step 930, the appropriate application profile converts the data into sensor specific data, i.e., data that can be written to the particular hardware/software of the WSN. At step 940, the converted data/command is written to the specified WSN.

By using the above-disclosed WSF, a user can read data and/or write data to any WSN irrespective of the hardware/software used on the WSN. By having the ability to create user defined data readers, application profiles, and data handlers, a user can read/write data of any type from/to any WSN. While the present disclosure discusses exemplary embodiments, it will be appreciated and understood that modifications may be made without departing from the scope of the disclosure.

What is claimed is:

1. A gateway connected to a Wireless Sensor Network (WSN) for transfer of data with the WSN, the gateway including:
a communication port connected to a WSN;
a communication port connected to a back-end network;
a data reader interface configurable to read sensor data from the WSN received from the communication port connected to the WSN, irrespective of a type of hardware or software used in the WSN;
an application profile interface configurable to receive the sensor data read by the data reader interface and convert the received data into a generic read data message irrespective of the type of hardware or software used in the WSN; and
a data handler interface configured to receive the generic read data message, process the received generic read data message based on a customized requirement or a standard requirement for the sensor data and send the processed data to the back-end network via the communication port connected to the back-end network.

2. The gateway of claim 1, wherein the gateway is configured to receive data from the back-end network destined for the WSN as a generic write data message, the application profile interface is configured to convert the received generic write data message into data suitable for the WSN, and the data reader interface is configured to receive the converted data and transfer the converted data to the WSN.

3. The gateway of claim 1, wherein the data reader interface includes a generic data reader class, the generic data reader class being configurable to read data from any WSN, irrespective of a network type via one or more network-specific data readers.

4. The gateway of claim 3, wherein the network-specific data readers include standard network data readers.

5. The gateway of claim 3, wherein the network-specific data readers include customized network data readers.

6. The gateway of claim 1, wherein the application profile interface is configured to convert the received data based on information within the received data by using a corresponding application profile.

7. The gateway of claim 6, wherein the corresponding application profile is a standard application profile.

8. The gateway of claim 6, wherein the corresponding application profile is a customized application profile.

9. The gateway of claim 1, wherein the data handler interface includes a generic data handler class, the generic data handler class being configurable to process and transfer data to an internal or external subsystem based on a customized requirement or a standard requirement of a user of the WSN.

10. A method of performing transfer of data between a Wireless Sensor Network (WSN) and a back-end network, the method comprising:
receiving sensor data from a WSN;
reading the received sensor data using a data reader interface configurable to read data received from the WSN irrespective of the type of hardware or software used in the WSN;
converting the read data into a generic read data message by using an application profile interface configurable to convert the read data irrespective of the type of hardware or software used in the WSN; and
transferring the generic read data to a back-end network.

11. The method of claim 10 further including:
receiving data from a back-end network as a generic write data message, the received data being destined for the WSN;
converting the generic write data message into data suitable for the WSN by using an appropriate application profile interface based on the WSN; and
transferring the converted data to the WSN by using an appropriate data reader interface based on the WSN.

12. The method of claim 10, including reading the sensor data using a generic data reader class that inherits attributes of the data reader interface, the generic data reader class being configurable to read data from any WSN, irrespective of a network type, via one or more network-specific data readers.

13. The method of claim 12, wherein the network-specific data readers include standard network data readers.

14. The method of claim 12, wherein the network-specific data readers include customized network data readers.

15. The method of claim 10, wherein the converting the read data into a generic read data message includes determining an appropriate application profile that inherits attributes of the application profile interface by extracting information from the read data, the extracted information indicating the appropriate application profile.

16. The method of claim 15, wherein the converting further includes: extracting sensor data by using the determined application profile; converting the extracted sensor data into appropriate engineering units; and populating at least a portion of a generic read data structure with the converted data to form the generic read data message.

17. The method of claim 15, wherein the application profile is a standard application profile.

18. The method of claim 15, wherein the application profile is a customized application profile.

19. A Wireless Sensor Framework for transfer of data between one or more Wireless Sensor Networks and a back-end network, the framework including:
a gateway;
a Wireless Sensor Network (WSN) connected to the gateway;
a back end network connected to the gateway, the gateway including:
a data reader interface configurable to read sensor data from the WSN, irrespective of a type of hardware or software used in the WSN;
an application profile interface configurable to receive the sensor data read by the data reader interface and convert the received data into a generic read data message irrespective of the type of hardware or software used in the WSN; and
a data handler interface configured to receive the generic read data message, process the received generic read data message based on a customized requirement or a standard requirement for the sensor data, and send the processed data to the back-end network.

20. The framework of claim 19, wherein the gateway is configured to receive data from the back-end network destined for the WSN as a generic write data message, the application profile interface is configured to convert the received generic write data message into data suitable for the WSN, and the data reader interface is configured to receive the converted data and transfer the converted data to the WSN.

21. The framework of claim 19, wherein the data reader interface includes a generic data reader class, the generic data reader class being configurable to read data from any WSN, irrespective of a network type via one or more network-specific data readers.

22. The framework of claim 19, wherein the application profile interface is configured to convert the received data based on information within the received data by using a corresponding application profile.

23. The framework of claim 22, wherein the corresponding application is a standard application profile.

24. The framework of claim 22, wherein the corresponding application is a customized application profile.

25. The framework of claim 19, wherein the data handler interface includes a generic data handler class, the genetic data handler class being configurable to process and transfer data to an internal or external subsystem based on a customized requirement or a standard requirement of a user of the WSN.
